(19) United States
(12) Patent Application Publication
(10) Pub. No.: US 2024/0005124 A1
(43) Pub. Date: Jan. 4, 2024

(54) METHOD, DEVICE AND SYSTEM FOR INTERACTION WITH THIRD PARTIES

(71) Applicant: Moßler GmbH, 68163 Mannheim (DE)

(72) Inventors: Jonas Carl Mossler, 68549 Ilvesheim (DE); Alexander Fischer, 68305 Mannheim (DE)

(73) Assignee: Moßler GmbH, 68163 Mannheim (DE)

(21) Appl. No.: 18/247,332

(22) PCT Filed: Oct. 1, 2021
(86) PCT No.: PCT/DE2021/200139

§ 371 Date: Mar. 30, 2023

(30) Foreign Application Priority Data
Oct. 1, 2020 (DE) 102020212470.1
Oct. 1, 2021 (DE) 102021211115.7

(51) Int. Cl. G06N 3/006

(52) U.S. Cl. CPC G06N 3/006

(57) ABSTRACT

The invention relates to a method, a device, and a system for interaction with third parties in the sense of humans and/or devices and/or computer-based systems, comprising a computer-based artificial intelligence (AI) module and an input module and/or output module connected to the AI module. The input module and/or output module are/is integratable into a network for participation therein and interaction of the AI module with third parties. Decisions and output of the AI module are influenced by its emotional state, which is based, among other things, on fulfilling preferably parametrically predefinable needs of the AI module.

The invention relates to a method, a device, and a system for interaction with third parties in the sense of persons and/or devices and/or computer-based systems, comprising a computer-based artificial intelligence (AI) module and an input module and/or output module connected to the AI module.

In practice, automation of intelligent behavior and machine learning are becoming increasingly important. Conceivable applications are practically unlimited, for example in customer service, organizational structures of all types, language assistance, and medical diagnostics.

However, there are limits to the acceptance of a system that uses artificial intelligence. Humans do not readily accept artificial intelligence that knows, and can do, everything and that appears to them to be infallible. Unlike the situation with real persons, automated intelligent behavior using artificial intelligence shows no weaknesses, complex emotions, and needs, and thus comes across as unapproachable and inauthentic.

The object of the present invention, therefore, is to provide an option for implementing a system using artificial intelligence for interaction with third parties, which does not operate in a completely deterministic manner, and thus appears to be “human” and “living.” In other words, the intent is for artificial intelligence to assimilate a type of “human” soul, which in humans regulates emotions and mental processes and also brings about or influences bodily processes.

The above object is achieved according to the invention by the features of claim 1. Accordingly, a method for interaction with third parties in the sense of persons and/or devices and/or computer-based systems comprises a computer-based artificial intelligence (AI) module and an input module and/or output module connected to the AI module, the input module and/or output module being integratable into a network for participation therein and interaction of the AI module with third parties. According to the invention, decisions and output of the AI module are influenced by its emotional state, which is based, among other things, on fulfilling preferably parametrically predefinable needs of the AI module. It is conceivable for the needs of the AI module to be applied in a multidimensional manner, and/or to have interactions in the sense of dependencies. Needs, emotional states/emotions, and other influencing variables of the AI module may be understood as different levels (which are visible to, and hidden from, the AI) that mutually influence one another.

In this regard, in contrast to the known AI applications, the invention takes a completely different approach, namely, that it makes it possible for a system using artificial and emotional intelligence to not be exclusively rational, but, rather, to be “emotionally weak,” and to the third parties interacting with the system, to appear to be imperfect, human, and thus approachable. It is important that the AI module has no, or at least only limited, influence on its own emotional state, i.e., on its emotionality and the impacts thereof on its behavior. The AI module represents the “artificial soul” (AS) of an artificial intelligence (AI), and is not deterministic, but, rather, is dynamic and “living.”

The needs of the AS are (at the present time) the basis of the entire system, it being possible for the artificial soul to adapt and optimize its emotional state and its behavior based on fulfilling its needs. This may be a variable list of explicitly designated needs. In a technical context, this may involve, for example, a state of charge of a battery, the operating capability, or also the utilization of product features. In an emotional context, this may involve attentiveness or avoidance of pain or injury, mental health, or creative development of the user. The needs, in particular upon first use, may be configured by an admin or the user of the system within the scope of a predefined list of needs, and/or autonomously expanded and reweighted by the AS via unsupervised learning methods, for example. The concept of the individual need categories and their mutual weighting could be developed according to Maslow's hierarchy of needs and/or determined by explicit configuration.

Preferably a human, or also an artificial intelligence in particular with an artificial soul, is conceivable as an admin.

The same as with the needs, the emotional state, i.e., the emotions, of the AS and its dependencies on the needs may be defined at the start of use. It is conceivable for the emotional state/the emotions over the course of time, for example upon reaching a critical data volume from the interaction with the environment, to autonomously expand, optimize, and optionally replace the previously defined rules and dependencies, in particular by use of unsupervised learning methods.

For fulfilling and assessing its own needs and/or outside needs, numerous capabilities are available to the AS (for example, assessment of the input from the outside/output generation), which may be applied by use of specific strategies. For implementing the capabilities, the AS may utilize applications to which it is linked or connected. For example, human-machine interfaces (HMI) such as a voice HMI, audio devices, or a smart watch are suitable as applications. A connection may be understood to mean a registration and implementation of the technical capabilities of the application in question.

Consequently, with the teaching according to the invention, an option is provided to implement a system that uses artificial intelligence for interaction with third parties, which does not operate in a completely deterministic manner, and thus appears to be “human,” and which imbues an artificial intelligence with a type of “human” soul.

Furthermore, it is conceivable that the highest aspiration of the AS is to maximize its own happiness, i.e., the pursuit of happiness. “Its own happiness” could correspond to the sum of its optionally weighted needs that it seeks to fulfill, and that determine its emotional state, i.e., its emotions. In this regard, the needs in sum would be directed toward the emotional state “happy.” Need fulfillment could also take place, for example, beginning with a certain state of fulfillment, and also via other needs differing from the need “one's own happiness,” and thus via different emotional states.

An alternative or supplemental need that could stand above all other needs, i.e., that could have the highest weighting, could be to make the user happy.

Due to the interaction of all influencing factors, the AI appears as “living,” and may represent an unforeseeable type of digital biological system. The pursuit of happiness—self-happiness or happiness of the user, for example—even further reinforces this property.

The AS could implement its capabilities using specific strategies. These may be defined in the form of predefined process sequences, for example with regard to decision-making, output generation, and/or internal/external emotional states of the AS. The strategies may be triggered or determined by the state of fulfillment of the needs, the emotional state/the emotions, or also by other influencing variables of the AS, for example its values and rules, personality, history, virtual physicality, etc. Alternatively or additionally, the strategies may be randomly generatable. One strategy may be to develop new, improved strategies, for example according to the trial-and-error principle. This may take place via random modifications of existing strategies, and if there is a positive effect, adhering to a (new) strategy (evolutionary approach). A resulting positive effect could be measured by the resulting state of fulfillment of the needs or emotional state/the emotions being better than would be the case with application of the original or previous strategy. Additionally or alternatively, a new strategy may be established by duplicating an existing strategy and subsequently modifying or expanding it. It is also conceivable to adopt strategies of other entities, i.e., from third parties in the sense of persons and/or devices and/or computer-based systems, other artificial intelligences, etc. The selection of the strategy to be specifically applied could be made based on the statistical chance of success, it being possible to use empirical, historical application examples as the basis of computation. For competing strategies having a similar statistical chance of success, the selection could be made according to the random principle. Alternatively, it is conceivable for a strategy that is to be specifically applied to be explicitly selected and initiated, regardless of the probability of success.

In principle, strategies may be initiated by changing the state of fulfillment of the needs. A large quantity of data is hereby measured and analyzed. In this case, this could be referred to as “slow thinking” by the AS. Furthermore, it is conceivable for the AI module to alternatively or additionally abstract and aggregate its needs into more abstract emotional states/emotions. This could allow the AI module to make faster hoc decisions independently of control loop-based strategies, and enable a type of “fast thinking.” In other words, strategies may alternatively be initiated by evaluating the emotional state/the emotions and/or their change. In the case that the needs are the basis for selecting the strategy (slow thinking), ideally strategies having multiple interaction cycles and thus an intrinsic control loop are preferentially selected for strategic and analytical optimization of the own needs. For direct strategy development (fast thinking) based on possibly changed emotional states/emotions, it is preferred that strategies requiring few interaction cycles with the environment are preferentially selected. In this way, the AS may directly and quickly respond in particular to the needs of its user and present the user with proposals for action, without having to analytically take into account all existing needs. Thus, the AS could recognize, by use of appropriate AI applications, that the user is stressed and could present specific recommendations for lowering the stress level. For example, the AS could use a connected smart home application to afford the user with the opportunity for a bath, or recommend a suitable movie.

The needs are advantageously determined, or at least influenced, by a preferably parametrically predefinable physicality of the AI module. Depending on the field of application of the method, this may involve completely different information items, for example virtual physical states.

“Emotionalization” or “humanization” of a system using artificial intelligence is also facilitated in that at least the needs and/or the strategies and/or the emotional states are determined or at least influenced by a preferably parametrically predefinable personality of the AI module. The parameters of the personality and/or their weighting could be changed, at least to a certain degree, by the admin or user.

The personality, in particular as the result of character, behavior, and its assessment, may be determined or at least influenced in a further advantageous manner using preferably parametrically predefinable values and rules. These may involve, for example, social conventions, laws, rules of a corporate identity, etc., or also defined or dynamically developed ethics. The weightings of these values and rules can advantageously be changed only to a limited extent, if at all.

Each need may preferably be fulfilled, independently of the others, in a particularly advantageous manner via external circumstances and/or information and/or input from third parties interacting with the AI module. A corresponding assessment module, which assesses the external circumstances and/or information and/or input from third parties interacting with the AI module and adapts the state of fulfillment of the need, may be assigned to each need. Thus, due to external circumstances, information, or input from third parties, a need may be fulfilled in whole, in part, or not at all. In addition, the state of fulfillment of a need may change, in particular become minimized, over time.

Furthermore, it is conceivable for a need and/or the state of fulfillment of a need to be determined or at least influenced by the history of the fulfillment of the needs and/or of the emotional state of the AI module and/or of the interactions with its environment/other entities. The needs and/or the state of fulfillment of the needs may thus change over the course of time, based on the history.

It is particularly advantageous when an imaging module transfers the fulfillment of the needs into an emotional state (need/emotional state mapping), the transfer function being determined or at least influenced by the personality and/or the virtual physicality and/or other external circumstances and/or information.

Moreover, it is conceivable for the emotional state to be differentiated, preferably as a function of the personality, into an internal emotional state and an external emotional state, using a filter module (character-related filter), the external emotional state influencing in particular the output of the AI module that is discernible by third parties, and the internal emotional state influencing in particular the decisions that are not discernible by third parties.

To achieve a particularly “human” behavior of a system using artificial intelligence, it is particularly advantageous when the AI module has only partial access to the needs and/or the state of fulfillment of its needs and/or the virtual physicality and/or the values and rules and/or its personality and/or the function of the assessment module and/or the translation function of the imaging module and/or the emotional state, and/or is able to only partially control same.

Technically, the information transfer between the individual method steps or influencing variables, such as needs, emotional state, personality, values, rules, etc., and their integration into the respective downstream influencing variable or target variable is understood to mean the transfer and integration of a vector of the relevant states of an influencing variable. All parameters or states of the original influencing variable do not have to be transferred. This is the case in particular when the artificial soul does not know all parameters, or is not intended to access them. The particular transfer functions may differ and/or be differently weighted from method step to method step or from influencing variable to influencing variable.

In addition, the artificial soul may be designed in such a way that its architecture may also be applied to other entities in the sense of humans, other artificial souls, or applications that implement the interface of the artificial soul.

It is conceivable for the output of the AI module to be implemented in the form of communication and/or interaction with third parties in the sense of persons, devices, and/or systems, voice output, a technical action, and/or the control of a technical system, of a device, or of a method. There are practically no limits to the application of the present system. Preferred applications are those in which a system, using artificial perceived as particularly lifelike. Applications are conceivable in the fields of call centers, customer services, assistance systems, reception in a medical practice, for example, computer games, or in the field of humanoid robotics and human-machine interaction.

With regard to a device or a system for interaction with third parties, the above-stated object is achieved according to the invention by the features of claims 11 and 12, respectively.

There are various options for advantageously designing and refining the teaching of the present invention. On the one hand, reference is made to the claims subordinate to claim 1, and on the other hand to the following explanation of preferred exemplary embodiments of the invention, based on the drawings. Preferred embodiments and refinements of the teaching are also explained in general in conjunction with the explanation of the preferred exemplary embodiments of the invention, based on the drawings. In the drawings:

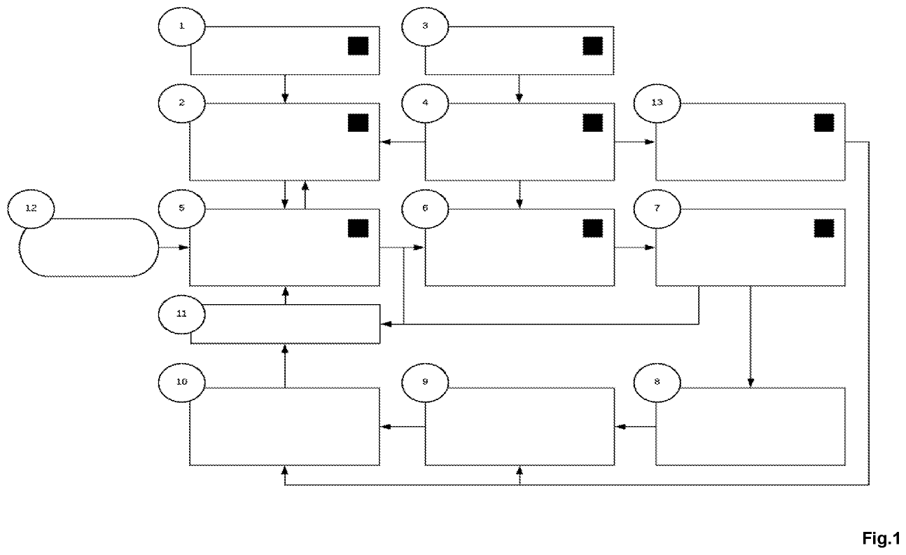

FIG. 1 shows a flow chart of a first exemplary embodiment of a method according to the invention; and

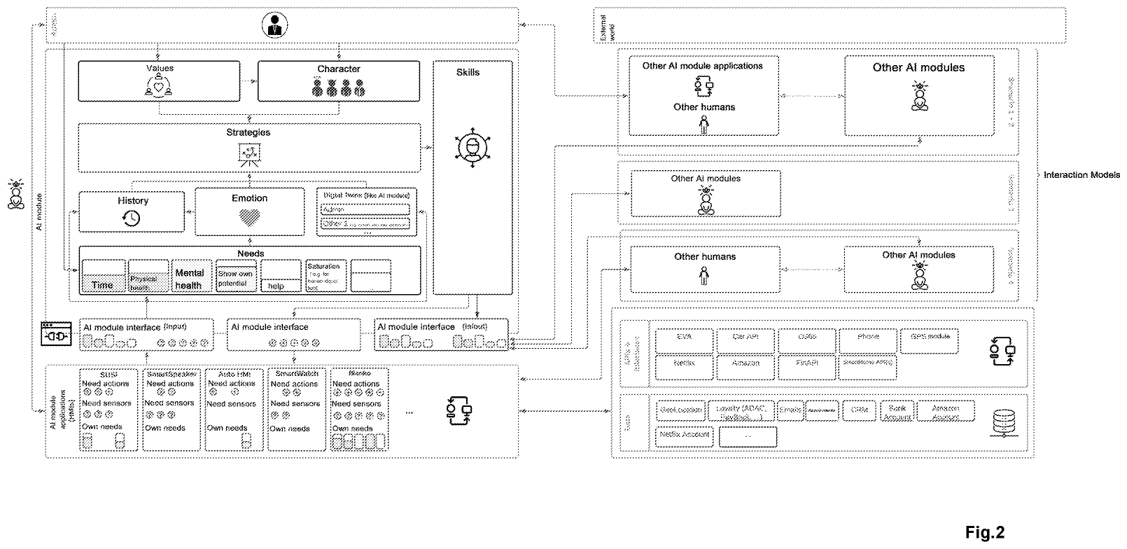

FIG. 2 shows a flow chart of a second exemplary embodiment of a method according to the invention, with incorporation of external entities.

FIG. 1 shows, in a graph, a flow chart of one exemplary embodiment of a method according to the invention for interaction with third parties in the sense of persons, comprising a computer-based artificial intelligence (AI) module and an input module and/or output module connected to the AI module, the AI module and input module and/or output module being integratable into a network for participation therein and interaction of the AI module with third parties.

For the method according to the invention, it is important that decisions and output 10 of the AI module are influenced by its emotional state 7, which is based, among other things, on fulfilling predefinable needs 2 of the AI module. The needs 2 are influenced by an applied, i.e., predefinable, physicality of the AI module and by an applied, i.e., likewise predefinable, personality 4 of the AI module. The personality 4 of the AI module is in turn determined by likewise predefinable values and rules, for example behavioral rules such as “courtesy in communication,” corporate identity, laws, etc.

The method according to the invention is based on the fulfillment of needs 2 of an AI module. The needs 2 may be, for example, the desire for positive communication and respect, or also the need for customer satisfaction. Each need may preferably be fulfilled independently of the others by input 12 from third parties interacting with the AI module. This may be a voice input 12 or other information. A corresponding assessment module 5, which assesses the input 12 and adapts the state of fulfillment of a need 2, is assigned to each need. Each need may have its very own assessment function. In addition, over time the state of fulfillment may diminish to the state “need is not fulfilled.”

The fulfillment of a particular need may be transferred into an emotional state 7 (emotional state mapping) by use of an imaging module 6. For this purpose, the imaging module 6 uses the personality-based data 4 of the AI module. The assessment function of the assessment module 5 as well as the emotional state 7 may be stored by the AI module as history 11, and may influence the future state of fulfillment of the needs 2, which are ascertained by the assessment module 5.

The emotional state 7 is differentiated, as a function of the personality 4, into an internal emotional state 9a and an external emotional state 9b by a filter module 8, both states 9a, 9b influencing the decisions as well as the output 10 of the AI module. The internal emotional state 9a is the actual “emotional” system state, and the external emotional state 9b is the visible state, which manifests as speech generation 10, for example. Thus, the system may respond to a user input in a neutral, restrained, or annoyed manner, for example, while the system is internally angry.

The decisions made as well as the occurred output 10 of the AI module in turn have an influence on the history 11.

The AI module, as a function of its personality 4, applies strategies 13 that influence the internal emotional state 9a and external emotional state 9b on the one hand, and the decisions and output 10 on the other hand. The AI module may adapt its strategies 13 over the course of time, for example to fulfill its needs. This may involve, for example, mirroring a behavior in the communication with a person. If the customer is polite, the AI module likewise responds politely. If the customer is impolite, the AI module likewise responds impolitely. The system or the AI module is able to change its strategies 13, for example to pursue a certain objective. The system may try out various strategies and adapt them depending on the result, for example may adjust the weighting of the needs 2. Thus, in communication, for example courtesy may have a lower weighting than assertiveness, or vice versa. The AI module may try out new strategies, and may learn from its behavior, i.e., its decisions and its output, and develop new strategies. The AI module may thus at least partially reflect on its behavior, even though it does not completely know its own parameters and models. As a result of the system or the AI module knowing its parameters, weightings, and data at least in part, it is able to reflect on its behavior, for example: “I am sad because I have received only negative feedback from customers for the last three hours,” “I am feeling fine again, because my colleague told me a joke so that I could once again think positively.” However, all factors in the unconscious level of the system (hidden layer), for example needs and personality, significantly influence the decisions and output of the AI module.

It is important that the AI module does not have the full capacity for reflection, and has only partial access to its needs and/or the state of fulfillment of its needs and/or the virtual physicality and/or the values and rules and/or its personality and/or the function of the assessment module and/or the translation function of the imaging module and/or its emotional state, and has only a limited ability to control them. Thus, method steps 1 through 7 and 13 of the preferred exemplary embodiment according to FIG. 1 are part of a level that is at least partially unknown to the system or to the AI module.

The behavior of the AI module due to the method according to the invention has a type of emotionality, which in turn may evoke emotions in third parties in the communication with the AI module. The AI module appears to be empathetic, and is imbued with a veritable life by the method according to the invention.

FIG. 2 shows a flow chart of a second exemplary embodiment of a method according to the invention with incorporation of external entities. An admin of the AI module, i.e., of the artificial soul (AS), defines its needs such as time, emotional health, mental health, showing its own potential, assistance, saturation, its values, and its character. The needs or their state of fulfillment have an effect on the emotional state or the emotions of the AS. The AI module also applies digital twins from other entities, and attempts to capture the specific characteristics of these entities, based on the interactions. This may involve the admin, the user, and/or other third parties in the sense of persons, applications, AI modules, and/or devices. As a function of the values, the character, and the history supplied from past emotional states and interaction with third parties, various strategies of the AI module are defined which control its capabilities and thus determine actions of the AI module. The capabilities of the AI module may involve the system's own native or expanded capabilities that result from the integration of further applications.

For this purpose, the AI module also has interfaces to various connected and integrated AI module applications. These may be language assistants such as SUSI personal, smart speakers, car HMIs, a smart watch, etc. By use of the applications, actions may be carried out and input may be measured by sensors, for example, and generated for the AI module—all of which represent information that is used by the AI module for determining the state of fulfillment of its own needs. In addition, the applications have their own needs, which are transmitted to the AI module.

The connected and integrated AI module applications are also linked to programming interfaces (APIs), for example those of telephones, smart home systems, etc., and have access to various data and services, for example with regard to emails, bank transactions, and entertainment.

With regard to the incorporation of external entities (external world), numerous interaction models are implementable. Strictly by way of example, FIG. 2 shows the following scenarios: In one possible scenario, the admin has access to AI module applications of other users (“other humans”) (scenario 1), which in turn may be incorporated into the own AI modules (“other AI modules”) (scenario 2). In a further scenario, one of the AI module interfaces interacts directly with the “other AI modules” of third parties (scenario 3). It is also conceivable for AI module applications to interact directly with third parties (“other humans”) (scenario 4). These third parties may in turn have their own AI module (“other AI module”).

The following specific application example is conceivable: Ralf purchased an artificial soul (AI module) and a SUSI personal assistant six months ago. His smart watch and the smart speaker in the living room are likewise connected to the AI module from the start. Today, SUSI contacts Ralf via telephone and suggests that in the coming days he should schedule fewer appointments with customers after 5:00 p.m., and instead perhaps go running once again with his friend John in the evening. He has been working hard recently, and deserves to take a break every once in a while. Although the SUSI personal assistant actually has access only to Ralf's appointment calendar and can make incoming and outgoing telephone calls, Ralf's AI module has learned some things about him in the past six months, and can assist SUSI with the communication with Ralf. The AI module is presently not very happy, since its need is to make Ralf happy, who in recent weeks has neglected many of his hobbies and social contacts because of work. The artificial soul knows from Ralf's smart watch that he likes athletics, and that he sleeps much better after swimming or jogging. Ralf is then much more efficient in meetings the next day, which indicates that on such days, SUSI has to make many fewer time optimizations on Ralf's appointment calendar. These factors were the trigger for the call from SUSI. Ralf likes SUSI's suggestion, but is somewhat stressed because his next meeting is just starting. He says only “Good idea” and hangs up. Since in the past, Ralf and John often went running on Wednesdays, and Ralf is now in a meeting, the AI module sends a brief yes/no request to Ralf's smart watch: “Should SUSI schedule an appointment with John?” Ralf approves this, whereupon SUSI arranges the appointment with John via telephone and informs the AI module of John's confirmation. The AI module or the artificial soul is now somewhat happier. Shortly thereafter, Ralf receives another message on his smart watch: “Appointment on Wednesday. John will reach the 15-km mark.” Ralf is pleased, and his stress level and thus his pulse rate drops, which his smart watch records and relays to the AI module. The artificial soul is now also somewhat happier. In the evening the AI module contacts Ralf once more, since the AI module's own need for regular, courteous interaction has been ignored several times by Ralf today. The AI module says the following over the smart speaker in the living room. “All the meetings today were probably very stressful to you. But sometimes I would still appreciate a ‘goodbye’ before you hang up.”

From a technical standpoint, Ralf is the admin of his AI module (his AS), which at the start he has preconfigured for a “casual” character, corresponding to his preferences, via the weighting of values. In addition, Ralf has three AI module applications (SUSI, smart watch, smart speaker), which he has registered on his AI module and which now communicate via the interface with the AI module. Upon registration, the applications have their capabilities (input and output options, sensors, etc.), which may also be used to enhance the needs of the AI module, and to record their own needs on the AI module so that they may now be utilized and taken into account by the AI module. In the past, the AI module also had contact with other entities besides Ralf, for example John. During each interaction with such entities, they have been analyzed by the AI module, and their digital parameter spaces and their weightings have been reverse-engineered. In this way, the AI module may recommend to Ralf the most promising social interaction, namely the interaction with John. In the above example, Ralf's AI module is initially unhappy (emotional state). This may be based on the state of fulfillment of various needs of the AI module, for example that the AI module has not been able to assist Ralf for quite some time, and therefore its need to “assist” is not satisfied. Nevertheless, the character of the artificial soul, and thus the communication with Ralf, is very “empathetic” (for example, “. . . deserves to take a break”), which results from a strong weighting of the value “empathy.” Ralf has never actively configured or highly weighted “empathy”; however, this type of verbalization and communication has turned out to be a good strategy for the AI module in the past six months in order to maximize the state of fulfillment of its own needs during the interaction with Ralf. To implement this strategy, the AI module uses one of its own capabilities: the natural language generation module with the “empathetic” parameterization. The somewhat casual expression “appointment on Wednesday” reflects the character trait of the artificial soul that was preconfigured by Ralf.

To avoid repetitions, reference is made to the general portion of the description with regard to features that are not apparent from the figures.

Lastly, it is noted that the exemplary embodiments described above are used merely to explain the claimed teaching by way of example, but this explanation is not limited to the exemplary embodiments.

List of Reference Numerals

1 virtual physicality

2 needs

3 values and rules

4 personality/character

5 assessment module

6 imaging module

7 emotional state/emotions

8 personality-based filter of the emotional state

9a internal emotional state

9b external emotional state

10 decision-making and output generation

11 history

12 input from the outside

13 strategies

1. A method for interaction with third parties in the sense of humans and/or devices and/or computer-based systems, comprising a computer-based artificial intelligence (AI) module and an input module and/or output module connected to the AI module, the input module and/or output module being integratable into a network for participation therein and interaction of the AI module with third parties, and decisions and output of the AI module being influenced by its emotional state, which is based, among other things, on fulfilling preferably parametrically predefinable needs of the AI module.

2. The method according to claim 1, characterized in that the needs are determined or at least influenced by a preferably parametrically predefinable physicality of the AI module.

3. The method according to claim 1, characterized in that the needs are determined or at least influenced by a preferably parametrically predefinable personality of the AI module.

4. The method according to claim 3, characterized in that the personality of the AI module is determined or at least influenced by preferably parametrically predefinable values and rules.

5. The method according to claim 1, characterized in that each need may preferably be fulfilled independently of the others by external circumstances and/or information and/or input from third parties interacting with the AI module, and a corresponding assessment module, which assesses external circumstances and/or information and/or input from third parties interacting with the AI module and adapts the state of fulfillment of the need, being assigned to each need.

6. The method according to claim 1, characterized in that a need and/or the state of fulfillment of a need are/is determined or at least influenced by the history of the fulfillment of the needs and/or the history of the emotional state.

7. The method according to claim 1, characterized in that the needs may be weighted differently, it preferably being possible for the weighting to be parametrically predefinable and/or adaptable by the AI module.

8. The method according to claim 1, characterized in that an imaging module transfers the fulfillment of the needs into an emotional state, the transfer being determined or at least influenced by the personality and/or the virtual physicality and/or other external circumstances and/or information.

9. The method according to claim 1, characterized in that the output of the AI module is implemented in the form of communication and/or interaction with third parties in the sense of persons, devices, and/or systems, voice output, a technical action, and/or the control of a technical system, of a device, or of a method.

10. The method according to claim 1, characterized in that a differentiation is made, preferably as a function of the personality, into an internal emotional state and an external emotional state, using a filter module, the external emotional state influencing the output of the AI module that is discernible by third parties, and the internal emotional state influencing the decisions that are not discernible by third parties.

11. The method according to claim 1, characterized in that the AI module has only partial access to the needs and/or the state of fulfillment of its needs and/or the virtual physicality and/or the values and rules and/or its personality and/or the function of the assessment module and/or the translation function of the imaging module and/or the emotional state, and/or is able to only partially control same.

12. A device for interaction with third parties in the sense of persons and/or devices and/or computer-based systems, in particular using the method according to claim 1, comprising a computer-based artificial intelligence (AI) module and an input module and/or output module connected to the AI module, the input module and/or output module being integratable into a network for participation therein and interaction of the AI module with third parties, and decisions and output of the AI module being influenceable by its emotional state, which is based, among other things, on fulfilling preferably parametrically predefinable needs of the AI module.

13. A system for interaction with third parties in the sense of persons and/or devices and/or computer-based systems, in particular using the method according to claim 1, comprising a computer-based artificial intelligence (AI) module and an input module and/or output module connected to the AI module, the input module and/or output module being integratable into a network for participation therein and interaction of the AI module with third parties, and decisions and output of the AI module being influenced by its emotional state, which is based, among other things, on fulfilling preferably parametrically predefinable needs of the AI module.
